(19) United States
(12) Patent Application Publication
(10) Pub. No.: US 2012/0200077 A1
(43) Pub. Date: Aug. 9, 2012

(54) Credit Card Security Cover

(76) Inventor: April Pohlman, Flagstaff, AZ (US)

(21) Appl. No.: 13/022,664

(22) Filed: Feb. 8, 2011

(51) Int. Cl. B42D 15/00

(52) U.S. Cl. 283/101

(57) ABSTRACT

A credit card security cover comprising a credit card, where the credit card includes a front face and a back face, a credit card number extending along the front face of the credit card, a signature strip positioned along the back face of the credit card, a card security code printed on the credit card, a security cover placed above the card security code wherein the security cover conceals the card security code to prevent a thief from viewing the card security code. The credit card security cover includes an adhesive backing to ensure that the security cover sticks to the credit card.

### BACKGROUND OF THE INVENTION

1. Field of the Invention

The present invention relates to an adhesive covering to place above the personal information of a user, including a card security code, a signature strip, a credit card number and the like to prevent another person from stealing and using this personal information.

2. Description of Related Art

With the growing convenience of performing personal banking or financing transactions over the internet, so does the threat of stolen information. Unfortunately, many individuals have been victims of identity theft, stolen banking information and stolen credit cards. Identity theft and false credit card charges can be detrimental to a person's personal and business banking accounts, their credit history, and their retirement and savings funds. The tampering may potentially ruin the individual's credit causing a time consuming and embarrassing recovery period.

Currently, several techniques have been developed to help a person prevent identity theft and stolen personal information. First, all credit cards include a card security code placed either on the front face or the back face of the credit card. The card security code is an additional number that is requested usually when processing transactions online, over the phone or when using a fax. This code ensures that the person submitting the credit card number actually has the credit card rather than merely a number. This method is a beneficial security feature but it does not prevent onlookers from simply viewing the card, and either memorizing the numbers or taking a picture of the card while at a retail store, restaurant or even a bank.

It would be beneficial in the art to provide an additional security feature to prevent personal information theft while using a credit card in public. It would also be desirable in the art to provide a security feature that does not inhibit use of the credit card for the user but merely prevents others from viewing any personal information printed on the card.

### SUMMARY OF THE INVENTION

An object of the present invention is to provide an adhesive strip that is placed over a card security code on a credit card to prevent another person from viewing the information.

Another object of the present invention is to provide an adhesive strip that is long enough to cover the signature strip of the credit card to conceal the signature of the user.

Another object of the present invention is to provide an adhesive strip that conceals the credit card number to prevent others from viewing and stealing the number.

In view of the foregoing disadvantages inherent in the prior art, the present invention provides a credit card security cover comprising a credit card, where the credit card includes a front face and a back face, a credit card number extending along the front face of the credit card, a signature strip positioned along the back face of the credit card, a card security code printed on the credit card, a security cover placed above the card security code wherein the security cover conceals the card security code to prevent a thief from viewing the card security code. The credit card security cover includes an adhesive backing to ensure that the security cover stick to the credit card.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a credit card front face in accordance with a prior art embodiment;

FIG. 2 depicts a perspective view of a credit card front face including a security cover in accordance with an exemplary embodiment of the present invention;

FIG. 3 depicts a perspective view of a credit card back face in accordance with a prior art embodiment; and

FIG. 4 depicts a perspective view of a credit card back face in accordance with an exemplary embodiment of the present invention.

Like reference numerals refer to like parts throughout the description of several views of the drawings.

### DETAILED DESCRIPTION OF THE DRAWINGS

The present invention relates to an adhesive covering to place above the personal information of a user including a card security code, a signature strip, a credit card number and the like to prevent another person from stealing the personal information. The present invention discloses a credit card security cover as a way to conceal bank and credit card information. The credit card security cover provides an adhesive strip that sticks to a front face or a back face of a credit card to conceal a zip code, a card security code, a signature or even a credit card number. The user is protected because their information cannot be seen by onlookers. By preventing the personal information from being stolen, the security covers also save banks, credit card companies and investment brokers because they help to significantly reduce the rate of identity and credit card theft, which ultimately saves money and cuts costs on claims and reimbursement funds.

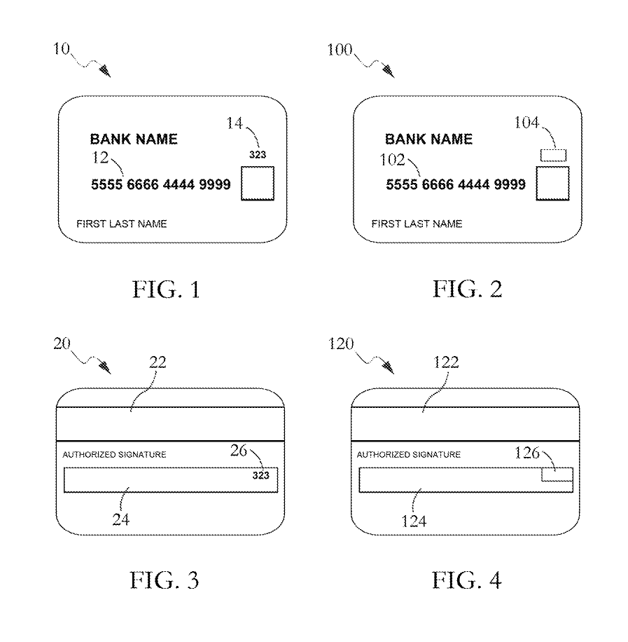

Turning now descriptively to the drawings, referring to FIG. 1, a perspective view of a credit card front face (10) is shown in accordance with a prior art embodiment. Conventionally, stretching across a length of the credit card front face (10) is a credit card number (12). Towards an end of the credit card number (12) may be a card security code (14), also known as the CSC. The card security code (14) is a specific identifier for the credit card number (12) for use in transactions when the credit card (10) is not present, for example those transactions occurring over the internet, by mail, fax or over the phone. The card security code (14) prevents credit card number (12) theft, by adding an additional security measure to ensure that the user actually posses the credit card (10). If the card security code (14) is stolen the thief may have free reign over the use of the credit card number (12).

Referring now to FIG. 2, a perspective view of a credit card front face (100) including a security cover (104) is shown in accordance with an exemplary embodiment of the present invention. A credit card number (102) stretches across the credit card front face (100). Instead of an exposed card security code at the end of the credit card number (102), the security cover (104) conceals the card security code. The security cover (104) prevents another person from viewing the card security code without permission of a credit card owner.

The security cover (104) may be an adhesive strip or include an adhesive backing that sticks to the credit card front face (100) and remains in place until removed by the owner. The security cover (104) is made from an opaque or nontransparent material so that the card security code cannot be seen through the material. The security cover (104) may be sized as a small rectangular adhesive strip to conceal the card security code. Alternatively, the security cover (104) may be available as a long adhesive strip to conceal the credit card number (102), thus preventing onlookers from viewing the credit card number (102).

Referring to FIG. 3, a perspective view of a credit card back face (20) is shown in accordance with a prior art embodiment. The credit card back face (20) includes a magnetic strip (22) extending across an entire upper portion. Below the magnetic strip (22) is a signature strip (24) where the user signs their signature. At an end of the signature strip (24) may be a card security code (26). Depending on the type of credit card, the card security code is either on the front of the credit card (as is FIG. 1) or on the back of the credit card (as shown). Accordingly, referring to FIG. 4, a perspective view of a credit card back face (120) is shown in accordance with an exemplary embodiment of the present invention. The credit card back face (120) may include a magnetic strip cover (122) to be placed above the magnetic strip. The credit card back face (120) may include a security cover (126) to block view of the card security code. Alternatively, the credit card back face (120) may include a signature strip cover (124) to conceal the owner's signature. The magnetic strip cover (122) may also be made of a a material that can block the magnetic code transfer that prevents another person from skimming credit card data in public and protect peoples valuable information from identity theft.

The security cover (126), the magnetic strip cover (122) and the signature strip cover (124) may be generally termed a security strip. The security strip may be an elongated adhesive strip or include an adhesive backing to attach above the magnetic strip, the signature strip and/or the card security code. The security strip may be easily removed and replaced by the credit card owner especially when needed for online, telephone and faxed transactions. The security strip may be made from an opaque material to prevent any concealed information from being seen. The opaque material may be available in a variety of colors depending on the preferences of the user. Alternatively, the security strip may be a transparent strip to be placed over the magnetic strip. The transparent strip prevents the credit card from properly functioning if stolen. The security strip may be available as a single page or sheet of adhesive paper comprising a plurality of security strips. This way the user may remove one security strip at a time to apply above the card security code, or any other documents that may contain the user's personal information. The security strip provides the additional safety measure needed for the user to protect themselves from credit card theft, identity theft and the like, leaving them with the feeling of assurance that their personal information will not be stolen.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A credit card security cover comprising:
a credit card, where said credit card includes a front face and a back face;
a credit card number extending along said front face of said credit card;
a signature strip positioned along said back face of said credit card;
a card security code printed on said credit card; and
a security cover placed above said card security code wherein said security cover conceals said card security code to prevent a thief from viewing said card security code.

2. The credit card security cover according to claim 1, wherein said security cover includes an adhesive backing to ensure that said security cover sticks to said credit card.

3. The credit card security cover according to claim 2, wherein said security cover is placed over said signature strip.

4. The credit card security cover according to claim 2, wherein said security cover is placed over said credit card number.

5. The credit card security cover according to claim 1, wherein said security cover is available on a single sheet of adhesive paper to include a plurality of security covers.
